(19) United States
(12) Patent Application Publication
(10) Pub. No.: US 2017/0198703 A1
(43) Pub. Date: Jul. 13, 2017

(54) Fan Powered by Mobile Device

(71) Applicant: Jeff Leitman, Irvine, CA (US)

(72) Inventor: Jeff Leitman, Irvine, CA (US)

(21) Appl. No.: 15/406,663

(22) Filed: Jan. 13, 2017

Related U.S. Application Data
(60) Provisional application No. 62/278,421, filed on Jan. 13, 2016.
(60) Provisional application No. 62/336,562, filed on May 13, 2016.

(51) Int. Cl. F04D 25/08; H02K 11/00; F04D 25/06; H01R 24/62

(52) U.S. Cl. CPC F04D 25/084; H01R 24/62; H02K 11/0094; F04D 25/0693; H01R 2107/00

(57) ABSTRACT

A fan powered by a mobile device is provided comprising an L-shaped body, a motor within the body, fan propeller blades attached one end of the L-shaped body, and a connector protruding from the other end of the L-shaped body that is capable of being inserted into a mobile device port in order to draw power from the mobile device. The connector types include a micro USB connector, a reversible micro USB connector and a reversible connector. The L shaped body is bent at an angle between 45 and 135 degrees and or can be bent at a 90 degree right angle. Additionally, a resistor attached to the micro USB connector to prevent power surges.

### CROSS REFERENCE TO RELATED APPLICATIONS

This application claims priority from provisional U.S. patent application Ser. No. 62/278,421 filed on Jan. 13, 2016 and provisional US patent application No. 62/336,562 filed on May 13, 2016.

### FIELD OF THE INVENTION

Embodiments of the invention generally relate to portable fans. Embodiments of the invention specifically relate to a portable fan powered by a mobile device

### BACKGROUND OF THE INVENTION:

Mobile devices, such as cellular and/or smartphones, have grown considerably in popularity. Various accessories and attachments can be plugged into and powered by phones, such as credit card readers and cameras. Most mobile devices have a port used for charging the device and transmitting data, such ports including micro USB (Universal Serial Bus) and other proprietary connectors. Additionally, these ports can be used to provide power from the mobile device to an accessory attachment.

Handheld portable fans can be carried by a user for individual cooling. Portable fans are generally powered by batteries. However, a mobile device through its charging port is sufficient to power a fan.

### SUMMARY

A fan powered by a mobile device is provided. This invention provides for a fan to be powered by a mobile device, such as cellular and/or smart phones, which most individuals carry around. Once plugged into the mobile device, the mobile device outputs a current to power the fan through the device's charging port, which includes but is not limited to micro USB, by connecting the fan via the appropriate device connector.

A fan powered by a mobile device is provided comprising an L-shaped body, a motor within the body, fan propeller blades attached one end of the L-shaped body, and a connector protruding from the other end of the L-shaped body that is capable of being inserted into a mobile device port in order to draw power from the mobile device. The connector types include a micro USB connector, a reversible micro USB connector and a reversible connector. The L shaped body is bent at an angle between 45 and 135 degrees and or can be bent at a 90 degree right angle. Additionally, a resistor attached to the micro USB connector to prevent power surges.

An alternative fan powered by a mobile device is provided comprising a first piece of a fan body, a second piece of a fan body such that the two pieces of the fan body are connected via a hinge, a motor within the first fan body piece; fan propeller blades attached to the first fan body piece and a connector protruding from the second fan body piece that is capable of being inserted into a mobile device port in order to draw power from the mobile device.

### BRIEF DESCRIPTION OF THE DRAWINGS

FIG. 1A is a front view of a fan embodiment.

FIG. 1B is a rear view of a fan embodiment.

FIG. 1C is a top view of a fan embodiment.

FIG. 1D is a bottom view of a fan embodiment.

FIG. 1E is a side view of a fan embodiment.

FIG. 2 is a diagram of a basic motor.

FIG. 3 is a diagram of a micro USB connector

FIG. 4 is a diagram comparison between a traditional micro USB connector, a reversible micro USB connector, and another reversible connector.

FIG. 5 is a diagram of a mobile device with an attached fan embodiment

FIG. 6A is a front view of a fan embodiment.

FIG. 6B is a rear view of a fan embodiment.

FIG. 6C is a top view of a fan embodiment.

FIG. 6D is a bottom view of a fan embodiment.

FIG. 6E is a side view of a fan embodiment.

FIG. 7 is a diagram of a mobile device with an attached fan embodiment

### DETAILED DESCRIPTION:

Reference will now be made in detail to the present embodiments discussed herein, illustrated in the accompanying drawings. The embodiments are described below to explain the disclosed invention by referring to the Figures using like numerals. It will be nevertheless be understood that no limitation of the scope is thereby intended, such alterations and further modifications in the illustrated device, and such further applications of the principles as illustrated therein being contemplated as would normally occur to one skilled in the art to which the embodiments relate. Those skilled in the art will recognize that other implementations may be performed that may include different structures or components that perform similar tasks.

A fan powered by a mobile device is provided. Mobile devices include, but are not limited to, cellular phones, smartphones, tablets, PDAs, and laptops.

While other handheld fans require batteries for operation, this invention provides for a fan to be powered by a mobile device, such as cellular and/or smart phones, which most individuals carry around. Once plugged into the mobile device, the mobile device outputs a current to power the fan. This is done through the device's charging port, which includes but is not limited to micro USB, by connecting the fan via the appropriate device connector. The fan has an L shaped body that projects the cooling breeze in the direction of the user. Additionally, a reversible connector, such as a reversible micro USB connector, allows the fan to always face the desired direction regardless of the mobile device type.

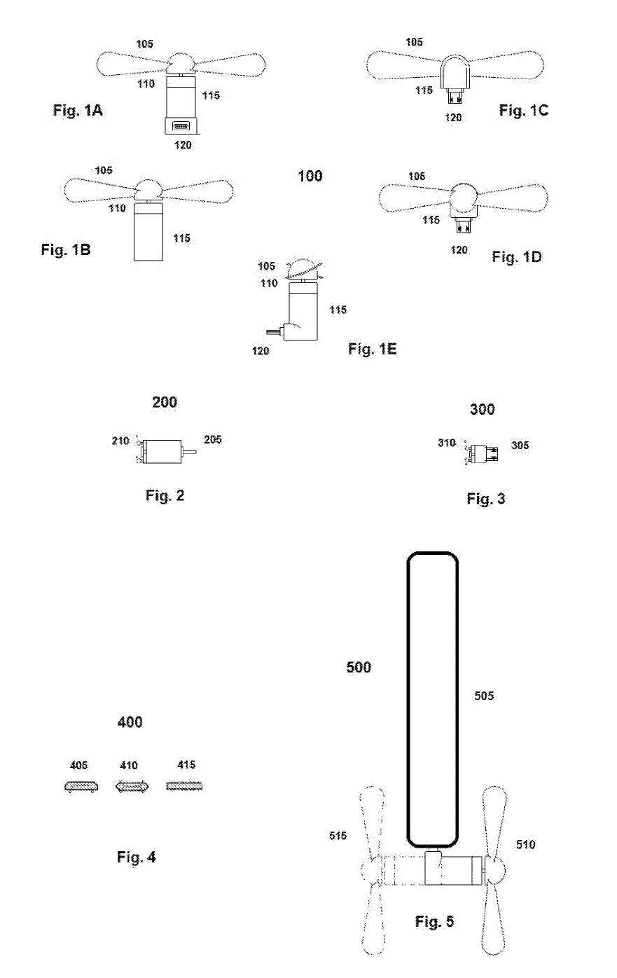

As illustrated in FIGS. 1A, 1B, 1C, 1D, 1E, a diagram of a fan embodiment 100 is provided. The fan comprises a propeller 105, small motor 110, L shaped body 115 and a mobile device connector 120. In the preferred embodiment, the connector is a micro USB connector (because of its prevalence as an industry standard) that is also a reversible micro USB connector. In alternative embodiments, the connector can be a standard micro USB connector or other connectors (reversible or not) that are not specified in this application.

Visible in FIGS. 1A-1E, the fan propeller 105 spins at a high rate of speed, pushing air at the user to provide a cooling breeze. The present embodiment depicts two blades, each one inch in size. Other embodiments may vary the number and size of the propeller blades. The propeller is connected to a motor 110, partially visible in FIGS. 1A, 1B and 1C, specifically the rotor shaft/axel. The motor 110 causes the fan propeller 105 to spin. Motor size and power may vary as long as the motor is able to spin the propeller at a sufficient speed. Most of the motor 110 is contained within one end of the solid, single piece, L shaped body 115 of the fan. The fan body must be large enough to contain the motor. The L shaped body bends at 90 degrees, though other alternative embodiments with angles between 45 and 135 degrees may accomplish the similar task of directing the fan at the user. The connector 120 protrudes from the other end of L shaped body 115, as depicted in FIGS. 1A, 1C, 1D, and 1E. In the preferred embodiment, the connector is a micro USB connector that is a reversible micro USB connector. In alternative embodiments, the connector can be a standard micro USB connector among other connectors.

As illustrated in FIG. 2, a diagram of a motor 200 is provided. The motor causes the rotor shaft/ axel 205 to spin. The rotor shaft/axel protrudes from the L shaped fan body and is attached to the fan propeller. The rest of the motor is located within the fan body 115. Power is provided to the motor via the +/− terminals 210. The motor is configured to be able to run on the volts provided by the appropriate connector, which includes USB, though the preferred embodiment provides for a motor with low power consumption.

As illustrated in FIG. 3, a diagram of a micro USB connector 300 is provided. The micro USB connector 305 is plugged into a micro USB port found on some mobile devices. The power received through the micro USB connector 305 from the mobile device is outputted through the +/− terminals 310. The micro USB connector 300 and motor 200 are connected via the corresponding +/− terminals 210, 310 within the body of the fan. One skilled in the art should recognize that the connection can be made directly or through an intermediary such as a wire or other means.

As illustrated in FIG. 4, a diagram comparison 400 of a standard micro USB connector, a reversible micro USB connector, and an alternative reversible connector is provided. The traditional micro USB plug 405 (specifically micro-B) has specific pins on the plug that correspond to pins on the receptacle. The plug 405 has a specific shape such that it must be inserted in such a way that the pins on the plug contact the pins on the receptacle. The reversible micro USB plug 410 differs in its hexagonal shape and the additional pins, such that the bottom portion of the plug mirrors the top portion of the plug. This allows for it to be inserted either upside down or right side up, since the pins on the plug will contact the pins on the receptacle when inserted either way. Micro USB is one of the most common connectors used with mobile devices, however, other connectors can be used in the performance of the inventive concepts contained herein.

Alternative connectors 415 exist that can only be inserted into their specific receptacle. Such connectors differ from other connectors in their shape and specific pin configuration. Such connector 415 may be similar to the reversible micro USB connector 410 in that the bottom portion of the plug mirrors the top portion of the plug. This allows for it to be inserted either upside down or right side up, since the pins on the plug will contact the pins on the receptacle when inserted either way.

As illustrated in FIG. 5, a diagram of a mobile device with an attached fan embodiment 500 is provided. The fan 510 is connected to the mobile device 505 via the connector. Upon insertion of the connector into the port on the mobile device 505, power is transmitted from the mobile device to power the motor and spin the fan propeller. As depicted in the present embodiment, the L shaped body causes the fan 510 to point 90 degrees from the micro USB port and in the direction of the mobile device user to provide optimal cooling. In other embodiments, the degree of the bend in the L shaped body can vary between the range of 45 degrees and 135 degrees. Additionally, when plugged into a device, the L shaped body shifts the fan downward such that the blades do not obscure the user's view or prevent the user from being able to operate the device. Other embodiments may shift the blades even further downward to provide greater access to the device screen/interface, by elongating the portion of the L shaped body with the connector. In the preferred embodiment, the connector is a reversible micro USB connector, which allows for the fan to be inserted in either direction 515. This provides the user with the ability to use the fan with different devices with varying upside down or right side up micro USB ports, so that regardless the device, the fan will point at the user. Additionally the user can reverse the fan direction to point it away from himself/herself and instead at others. A standard micro USB connector, among other connectors, can be configured with the fan to provide usage with different devices.

In embodiments which use a micro USB connector, a resistor can be added onto the micro USB connector. This resistor prevents power surges which can occur on certain mobile devices. On such devices, upon inserting the micro USC connector into the device, the vibration of the fan turning on can cause grounding of the positive and negative terminals. This can result in a power surge which disables the micro USB port which powers the fan. The addition of the resistor in the fan prevents the power surge and subsequent port shutdown from occurring.

In an alternative fan embodiment, instead of a single L shaped body structure, there are 2 separate fan body pieces that are connected by a hinge. The hinge allows for the fan to bend and change direction without having to remove and reinsert the fan via a reversible connector, such as a reversible micro USB connector.

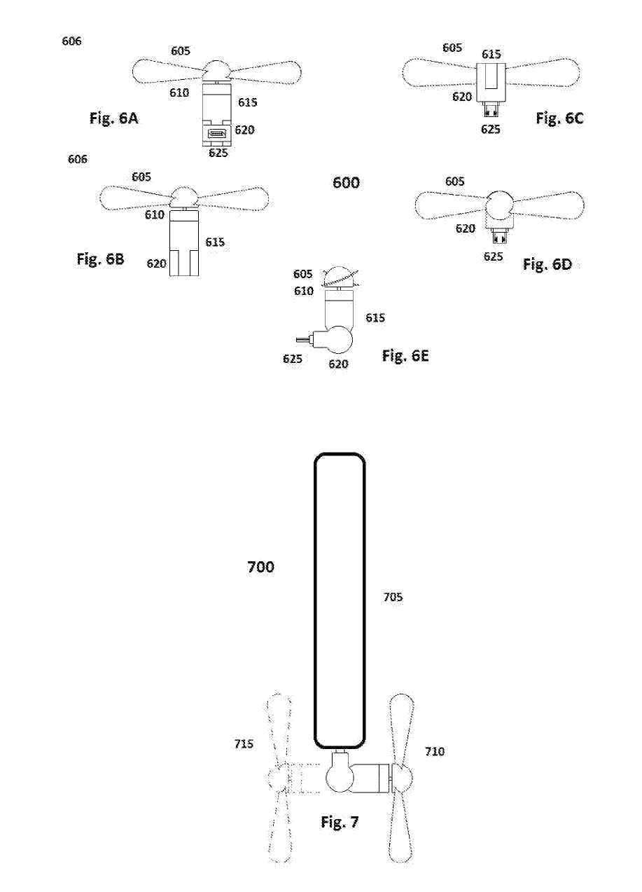

As illustrated in FIGS. 6A, 6B, 6C, 6D, 6E, a diagram of a fan embodiment 600 is provided. The fan comprises a propeller 605, small motor 610, a first body piece 615 connected via a hinge to a second body piece 620 and a mobile device connector 625. In the preferred embodiment, the connector is a micro USB connector (because of its prevalence as an industry standard). In alternative embodiments, the connector can be a standard micro USB connector or other connectors not specified in this application. Reversible connectors can be used; however, the hinge gives the fan the reversible functionality without the need to unplug and reinsert the fan.

Visible in FIGS. 6A-6E, the fan propeller 605 spins at a high rate of speed, pushing air at the user to provide a cooling breeze. The present embodiment depicts two blades, each one inch in size. Other embodiments may vary the number and size of the propeller blades. The propeller is connected to a motor 610, partially visible in FIGS. 6A, 6B and 6C, specifically the rotor shaft/axel. The motor 610 causes the fan propeller 605 to spin. Motor size and power may vary as long as the motor is able to spin the propeller at a sufficient speed. Most of the motor 610 is contained within one end of the piece of the body 615 of the fan. The fan body must be large enough to contain the motor. The first body piece 615 is connected via a hinge to a second body piece 620. The connector 625 protrudes from the other end of second body piece 620, as depicted in FIGS. 6A, 6C, 6D, and 6E. In the preferred embodiment, the connector is a micro USB connector. In alternative embodiments, the connector can be a reversible micro USB connector among other connectors.

Such a fan embodiment includes a motor 200 that causes the rotor shaft/axel 205 to spin. The rotor shaft/axel protrudes from the first piece of the fan body and is attached to the fan propeller. The rest of the motor is located within the first piece of body 615. Power is provided to the motor via the +/− terminals 210. The motor is configured to be able to run on the volts provided by the appropriate connector, which includes USB, though the preferred embodiment provides for a motor with low power consumption.

Such a fan embodiment includes a connector protruding from the second piece of the body, where the connector can be a micro USB connector 300. The micro USB connector 305 is plugged into a micro USB port found on some mobile devices. The power received through the micro USB connector 305 from the mobile device is outputted through the +/− terminals 310. The micro USB connector 300 and motor 200 are connected via the corresponding +/− terminals 210, 310 within the second body piece of the fan. One skilled in the art should recognize that the connection can be made directly or through an intermediary such as a wire or other means. Other connectors can be used which can include a reversible micro USB connector as well as alternative connectors that can only be inserted into their specific receptacle.

As illustrated in FIG. 7, a diagram of a mobile device with an attached fan embodiment [symbol] 00 is provided. The fan 710 is connected to the mobile device 705 via the connector. Upon insertion of the connector into the port on the mobile device 705, power is transmitted from the mobile device to power the motor and spin the fan propeller. As depicted in the present embodiment, the hinge between the first and second pieces of the fan body allows the fan 710 to point 90 degrees from the micro USB port and in the direction of the mobile device user to provide optimal cooling. The hinge allows the user to rotate the fan to point it away from himself/herself and instead at others. The hinge provides a means to lock the fan at the two opposing 90 degree right angle positions. This can be done by creating indentations that allow the fan to “click in” to place and maintain a position. Some embodiments allow for multiple configurations at the hinge such that the hinge can lock into place at degree intervals, common intervals including but not limited to 45 and 30 degrees. Additionally, when plugged into a device, the second piece of the fan body (with the protruding connector plug) shifts the fan downward such that the blades do not obscure the user's view or prevent the user from being able to operate the device. Other embodiments may shift the blades even further downward to provide greater access to the device screen/interface, by elongating this second piece of the fan body. A standard micro USB connector, among other connectors, can be configured with the fan to provide usage with different devices.

In embodiments which use a micro USB connector, a resistor can be added onto the micro USB connector. This resistor prevents power surges which can occur on certain mobile devices. On such devices, upon inserting the micro USC connector into the device, the vibration of the fan turning on can cause grounding of the positive and negative terminals. This can result in a power surge which disables the micro USB port which powers the fan. The addition of the resistor in the fan prevents the power surge and subsequent port shutdown from occurring.

The preceding description contains embodiments of the invention and no limitation of the scope is thereby intended.

That which is claimed is:

1. A fan powered by a mobile device comprising
An L-shaped body;
A motor within the body;
Fan propeller blades attached one end of the L-shaped body;
A connector protruding from the other end of the L-shaped body that is capable of being inserted into a mobile device port in order to draw power from the mobile device

2. The fan of claim 1, wherein the connector is a micro USB connector.

3. The fan of claim 2, wherein the connector is a reversible micro USB connector.

4. The fan of claim 1, wherein the connector is a reversible connector.

5. The fan of claim 1, wherein the L shaped body is bent at an angle between 45 and 135 degrees.

6. The fan of claim 5, wherein the L shaped body is bent at a 90 degree right angle.

7. The fan of claim 2 further comprising:
A resistor attached to the micro USB connector.

8. A fan powered by a mobile device comprising
A first piece of a fan body;
A second piece of a fan body;
Such that the two pieces of the fan body are connected via a hinge;
A motor within the first fan body piece;
Fan propeller blades attached to the first fan body piece;
A connector protruding from the second fan body piece that is capable of being inserted into a mobile device port in order to draw power from the mobile device

9. The fan of claim 8, wherein the connector is a micro USB connector.

10. The fan of claim 9, wherein the connector is a reversible micro USB connector.

11. The fan of claim 8, wherein the connector is a reversible connector.

12. The fan of claim 8 further comprising a means for locking the hinge in position to form opposing 90 degree right angles.

13. The fan of claim 8 further comprising a means for locking the hinge in position at degree intervals.

14. The fan of claim 9 further comprising:
A resistor attached to the micro USB connector.
